(19) United States
(12) Patent Application Publication
(10) Pub. No.: US 2024/0166484 A1
(43) Pub. Date: May 23, 2024

(54) Extractor

(71) Applicant: Chester Brown Industries Pty Ltd, Port Kennedy (AU)

(72) Inventor: Peter Chester, Port Kennedy (AU)

(73) Assignee: Chester Brown Industries Pty Ltd, Port Kennedy (AU)

(21) Appl. No.: 18/515,207

(22) Filed: Nov. 20, 2023

(30) Foreign Application Priority Data
Nov. 21, 2022 (AU) 2022903500

(51) Int. Cl. B66F 11/00; B66F 1/00

(52) U.S. Cl. CPC B66F 11/00; B66F 1/00

(57) ABSTRACT

There is disclosed an extractor (10) for extracting an elongate body (12) from the ground. The extractor (10) includes a holding assembly (14) operatively adapted to hold the elongate body (12) to be extracted from the ground and a guide assembly (24) operatively associated with the holding assembly (14). The guide assembly (24) includes (i) a guide follower (26) for operative attachment to the holding assembly (14), and (ii) a guide (28) along which the guide follower (26) is caused to move when the elongate body (12) is extracted from the ground. The extractor (10) further includes a drive assembly (30) operatively associated with the guide follower (26). The drive assembly (30) is adapted to be coupled with a hand tool for applying torque to the drive assembly (30). Applying torque to the drive assembly causes the guide follower (26) to move along the guide (28) thereby to extract the elongate body (12) from the ground.

### CROSS REFERENCE TO RELATED APPLICATION

This application claims the benefit of Australian Patent Application No. 2022903500 entitled “EXTRACTOR”, filed Nov. 21, 2022, which is incorporated herein by reference.

### FIELD

This invention concerns an extractor. In particular, but not exclusively, the invention concerns an extractor for use in extracting elongate bodies from the ground. In one application the invention concerns an extractor for extracting bulkhead pins, used for securing temporary grain storage bulkheads, from the ground. The invention extends to an extractor for removing pipe posts, pickets and timber strainer posts from the ground.

### BACKGROUND

Operators of grain handling and storage facilities often use temporary bulkheads to store grain. Such temporary bulkheads are typically secured in position with the use of bulkhead pins. When such temporary bulkheads are to be collapsed it is required that the bulkhead pins be extracted from the ground. Removing bulkhead pins from the ground has proven cumbersome and potentially hazardous to personnel responsible for removal of those pins. Currently, front-end loaders or Bobcat™ loaders are employed to remove the pins. During a removal process the cutting edge of the loader buckets will apply an extraction force to the bulkhead pin. It is also known to employ an attachment/adapter connected to a loader bucket by which a bulkhead pin can be extracted. Such attachments have been known to fail, placing personnel extracting the bulkhead pin in danger of injury.

Several devices are supported by one or more posts or elongate bodies driven into the ground. Such devices include agricultural fences. An agricultural fence is a structure that encloses a parcel of land and is usually constructed from posts that are connected by lengths of wire. Agricultural fences play a key role in maintaining livestock. Not only do agricultural fences serve to prevent livestock from straying, but they also serve to protect livestock against predators.

A typical fence post comprises an elongate post body driven into the ground to carry load. One type of post commonly employed in constructing fences on farms is a so-called star picket. A star picket is generally produced from metal. Being produced from metal, a star picket has several benefits over timber posts. Those benefits include that star pickets are not prone to splinter, rot or to be eaten by termites. Star pickets further are generally cost effective as they tend to be long lasting and are quick and easy to install. A fence installer is simply required to hammer a star picket into the ground at a desired location without the need of complex or expensive equipment.

From time to time, it may become necessary to remove or relocate a fence. It then becomes necessary to remove or pull the fence posts from the ground. Removing fence posts can be a labour and time intensive exercise. One type of post remover employed specifically for removing a star picket comprises a plate having a star shape cut into it. The plate is required to be lifted at one end to remove the picket from the ground. Should the picket be in hard ground, the plate may bend the picket during a removal operation. Employing the plate remover also requires that wire be removed from the picket to provide a sufficiently large surface area for the plate to grip the picket. Despite removing wire from a star picket, plate-type removers remain prone to slipping.

Another mechanism employed to extract star pickets from the ground includes employing a chain with a half hitch placed around the picket to be removed. This mechanism is generally not effective as it is very prone to slipping.

### OBJECT

It is an object of the present invention to address the problems associated with the above-described mechanisms employed to remove elongate bodies from the ground, or at least to provide an alternative extractor for removing elongate bodies such as bulkhead pins, star pickets, pipe posts or wood strainers from the ground.

### SUMMARY

According to a first aspect there is disclosed herein an extractor for extracting an elongate body from the ground, the extractor including:
a holding assembly operatively adapted to hold the elongate body to be extracted from the ground;
a guide assembly operatively associated with the holding assembly, the guide assembly including (i) a guide follower for operative attachment to the holding assembly, and (ii) a guide along which the guide follower is caused to move when the elongate body is extracted from the ground; and
a drive assembly operatively associated with the guide follower, the drive assembly adapted to be coupled with a hand tool for applying torque to the drive assembly, applying torque to the drive assembly causing the guide follower to move along the guide, thereby to extract the elongate body from the ground.

Preferably the extractor includes a base adapted to support the guide assembly in an upright orientation when the elongate body is extracted from the ground.

Preferably the extractor includes a base member and two co-extensive, laterally spaced apart base arms outwardly extending from the base member.

Preferably the drive assembly includes a coupling adapted to couple with the hand tool, the coupling in use transferring torque from the hand tool to the drive assembly.

Preferably the hand tool is a cordless drill or a powered cordless impact wrench.

Preferably the coupling includes a hexagonal coupling head.

Preferably the extractor includes a hand tool holder operatively adapted to support the hand tool.

Preferably the hand tool holder is secured to an upright support mounted to the base member.

Preferably the hand tool holder includes two spaced apart holder arms which are connected by a transverse rest.

Preferably the extractor includes at least one wheel, typically two wheels, for transporting the extractor to a desired location.

Preferably the extractor includes a handle whereby a user steers the extractor to a desired location.

Preferably the drive assembly includes an elongate, longitudinally extending threaded drive rod.

Preferably the guide follower includes a threaded drive rod engaging formation, the drive rod engaging formation adapted to engage the drive rod such that pivotal movement of the drive rod imparts relative movement to the rod engaging formation, thereby causing the guide follower to move longitudinally along the guide.

Preferably the guide is an elongate upright.

In an embodiment the holding assembly includes a holding member having a slot adapted to slidably receive a portion of the elongate body.

In an alternative embodiment the holding assembly includes a clamp operatively adapted to clamp onto the elongate body.

Preferably the clamp includes a gripping formation complementally shaped to the outer surface of the elongate body to be extracted.

In an embodiment the gripping formation is shaped to accommodate the outer surface of a star picket.

In another embodiment the gripping formation is shaped to accommodate the outer surface of a T-picket.

In yet another embodiment the gripping formation is shaped to accommodate the outer surface of a pipe post.

In an alternative embodiment the holding assembly includes a chain.

### BRIEF DESCRIPTION OF THE DRAWINGS

Preferred embodiments of the invention will be described hereinafter, by way of examples only, with reference to the accompany drawings, wherein:

FIG. 1 is a perspective view of a first embodiment extractor;

FIG. 2 is a front view of the extractor of FIG. 1;

FIG. 3 is a side view of the extractor of FIG. 1;

FIG. 4 is a top view of the extractor of FIG. 1;

FIG. 5 is a bottom view of the extractor of FIG. 1;

FIG. 6 is a diagrammatic illustration of the extractor of FIG. 1 extracting a bulkhead pin from the ground;

FIG. 7 is a perspective view of a second embodiment extractor;

FIG. 8 is a front view of the extractor of FIG. 7;

FIG. 9 is a side view of the extractor of FIG. 7;

FIG. 10 is a top view of the extractor of FIG. 7;

FIG. 11 is a bottom view of the extractor of FIG. 7;

FIG. 12 is a diagrammatic illustration of the extractor of FIG. 7 extracting a star picket from the ground;

FIG. 13 is a perspective view of a third embodiment extractor;

FIG. 14 is a front view of the extractor of FIG. 13;

FIG. 15 is a side view of the extractor of FIG. 13;

FIG. 16 is a top view of the extractor of FIG. 13;

FIG. 17 is a bottom view of the extractor of FIG. 13;

FIG. 18 is a diagrammatic illustration of the extractor of FIG. 13 extracting a pipe post;

FIG. 19 is a perspective view of a fourth embodiment extractor;

FIG. 20 is a front view of the extractor of FIG. 19;

FIG. 21 is a side view of the extractor of FIG. 19;

FIG. 22 is a top view of the extractor of FIG. 19;

FIG. 23 is a bottom view of the extractor of FIG. 19;

FIG. 24 is a diagrammatic illustration of the extractor of FIG. 19 extracting a timber strainer post from the ground.

### DESCRIPTION OF PREFERRED EMBODIMENTS

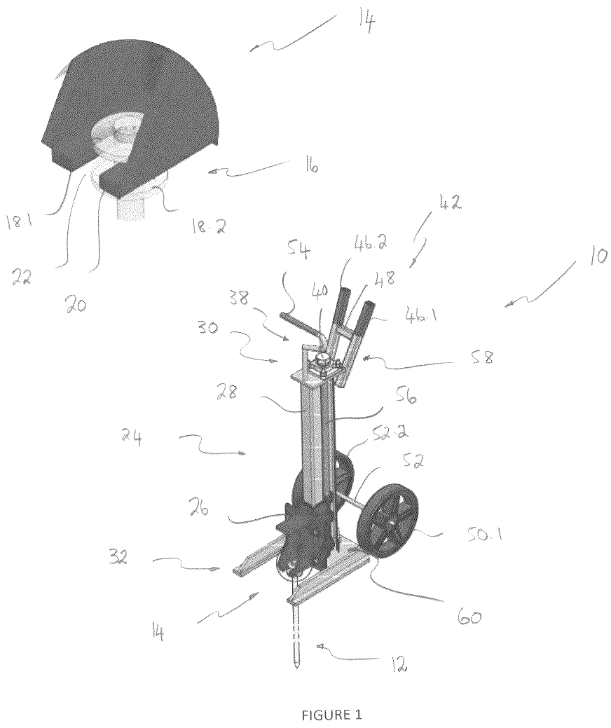

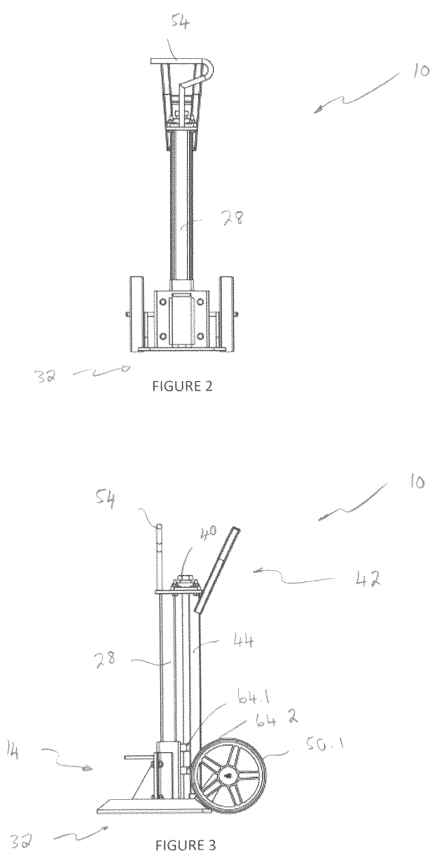

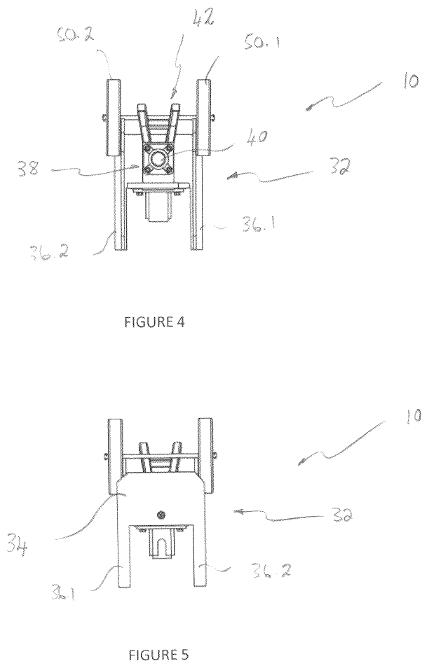

FIGS. 1 to 5 shown a first embodiment extractor, generally indicated with the reference numeral 10, for extracting an elongate body 12 from the ground. In this embodiment the elongate body 12 is a bulkhead pin. Specifically, the elongate body/bulkhead pin 12 is in use driven into the ground to secure a non-illustrated temporary grain storage bulkhead in position.

The extractor 10 includes a holding assembly 14 which is operatively adapted to hold the bulkhead pin 12 when it is to be extracted from the ground. As shown in FIG. 1, the bulkhead pin 12 includes at its upper end 16 two spaced apart flanges, namely an upper flange 18.1 and a lower flange 18.2. The holding assembly 14 in turn includes a holding member 20 having a slot 22 therein, the slot 22 being adapted to slidably receive a portion of the bulkhead pin 12. Specifically, the holding member 20 with its slot 22 is adapted to receive a portion of the bulkhead pin 12 which is located between the two spaced apart flanges 18.1, 18.2. The effect of this is that when an extraction force is applied to the holding assembly 14, such extraction force will be exerted on the upper flange 18.1 of the bulkhead pin 12, thereby to extract the bulkhead pin 12 from the ground.

The extractor 10 further includes a guide assembly 24 operatively associated with the holding assembly 14. The guide assembly 24 includes (i) a guide follower 26 for operative attachment to the holding assembly 14, and (ii) a guide 28 along which the guide follower 26 is caused to move when the elongate body/bulkhead pin 12 is extracted from the ground.

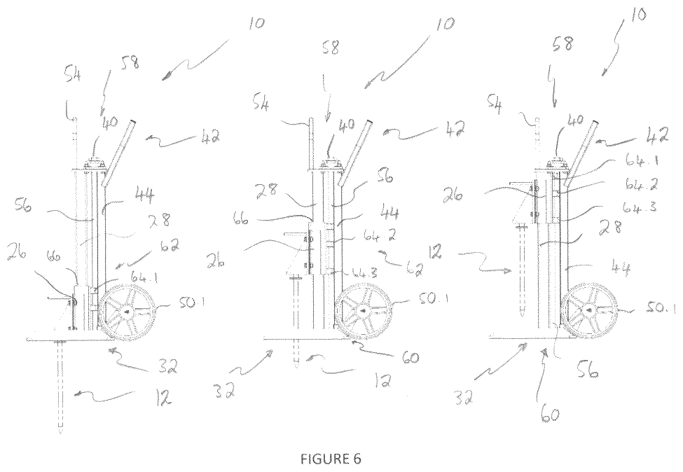

The extractor 10 also is provided with a drive assembly 30 operatively associated with the guide follower 26. The drive assembly 30 is adapted to be coupled with a non-illustrated hand tool which hand tool in use applies torque to the drive assembly 30. When torque is applied to the drive assembly 30, the guide follower 26 will be caused to move along the guide 28, thereby extracting the bulkhead pin 12 from the ground. FIG. 6 diagrammatically illustrates movement of the guide follower 26 along the guide 28 as the bulkhead pin 12 is extracted from the ground.

The extractor 10 is provided with a base 32 adapted to support the guide assembly 24 in an upright orientation when the bulkhead pin 12 is extracted from the ground. The extractor 10 includes a base member 34 and two co-extensive, laterally spaced apart base arms 36.1, 36.2 which outwardly extend from the base member 34.

The drive assembly 30 includes a coupling 38 adapted to couple with the non-illustrated hand tool. In use the coupling 38 transfers torque from the hand tool to the drive assembly 30. In this embodiment the coupling 38 includes a hexagonal coupling head 40.

The hand tool can be chosen from a range of hand tools such as a cordless drill or a powered cordless impact wrench. Depending on the features of the soil or ground surface form which the elongate body 12 is to be extracted a user can choose an appropriate hand tool that will impart sufficient torque to the drive assembly 30 to effect extraction.

The extractor 10 includes a hand tool holder 42 which is operatively adapted to support the hand tool. The embodiment hand tool holder 42 is secured to an upright support 44 mounted to the base member 34. The embodiment hand tool holder 42 includes two spaced apart holder arms 46.1, 46.2 which are connected by a transverse rest 48. In use, the hand tool will rest on the rest 48 when coupled to the hexagonal coupling head 40. The effect of this is that a user need not support the hand tool during an extraction process thereby limiting the strain on a user's body.

The extractor 10 includes two wheels 50.1, 50.2, mounted about an axle 52 for transporting the extractor 10 to a desired location. The extractor includes a handle 54 whereby a user steers the extractor 10 to a desired location by apply a pulling or pushing force on the handle.

The embodiment drive assembly 30 includes an elongate, threaded drive rod 56 longitudinally extending between a coupling end 58, supporting the coupling 38, and an opposing base end 60. A non-illustrated bearing is provided at the base end 58 to facilitate pivotal movement of the drive rod 56.

The guide follower 26 includes a threaded drive rod engaging formation 62, here in the form of three internally threaded ears 64.1, 64.2, 64.3. The drive rod engaging formation 62 is adapted to engage the drive rod 56 such that pivotal movement of the drive rod 56 will impart relative movement to the drive rod engaging formation 62. This, in turn, will cause the guide follower 26 to move along the guide 28.

In this embodiment the guide 28 is an elongate upright. The guide follower 26 defines a bore 66 such that the guide follower 26 is adapted to slidably move along the guide/upright 28 when the hand tool is activated and imparts torque to the drive rod 56.

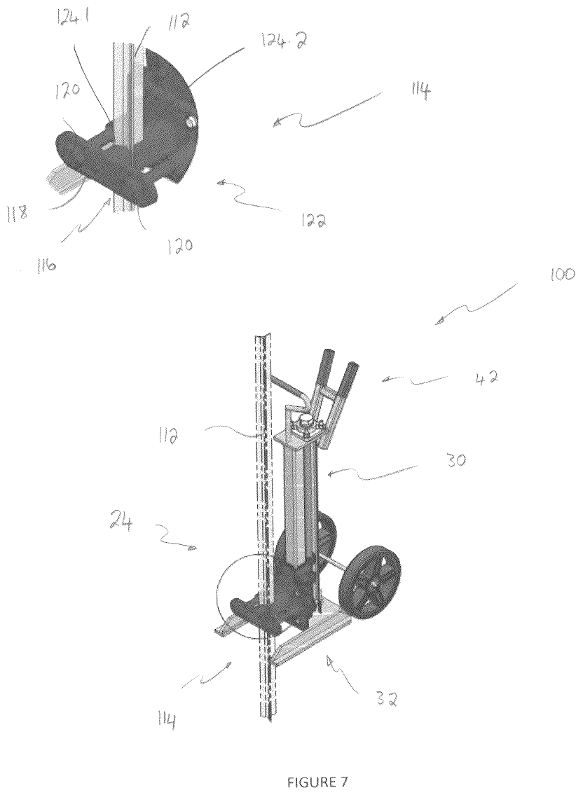

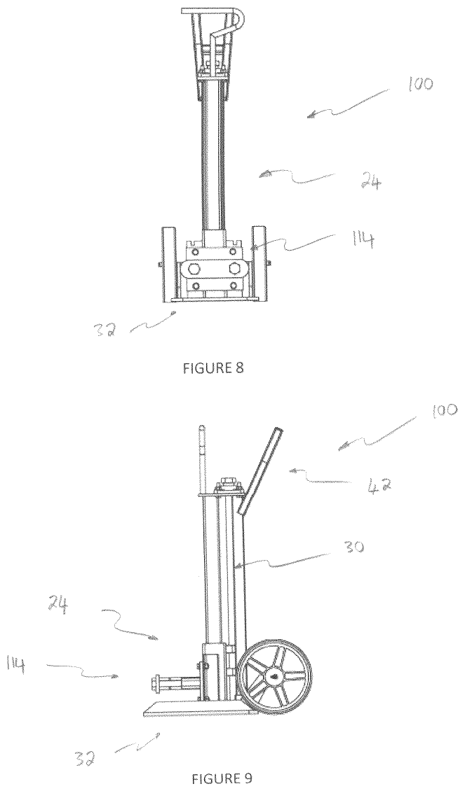

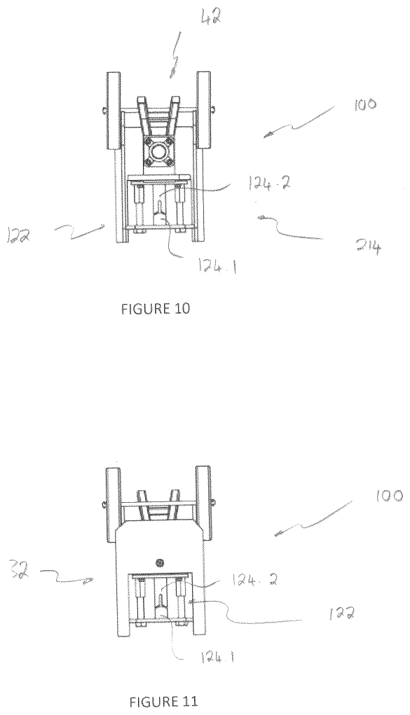

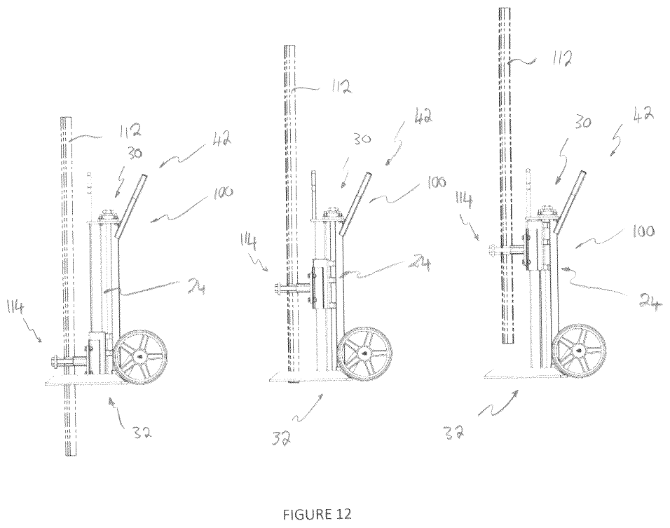

FIGS. 7 to 12 show a second embodiment extractor 100 which includes a guide assembly 24, drive assembly 30, base 32 and hand tool holder 42 similar to the first embodiment extractor 10. The extractor 100, however, differs from the extractor 10 in having a holding assembly 114 which defines a clamp 116 operatively to clamp onto an elongate body 112. The clamp 116 includes a clamp element 118 which includes two fasteners 120 which are fastened when it is required to secure to clamp an elongate body 112 in position.

The clamp 116 includes a gripping formation 122 complementally shaped to the outer surface of the elongate body 112 to be extracted. In this embodiment the gripping formation 122 is shaped to accommodate the outer shape of an elongate body 112, here in the form of a star picket. The gripping formation 122 includes two opposing gripping members 124.1, 124.2 which co-operate to grip the outer surface of the star picket 112 when it is to be extracted from the ground.

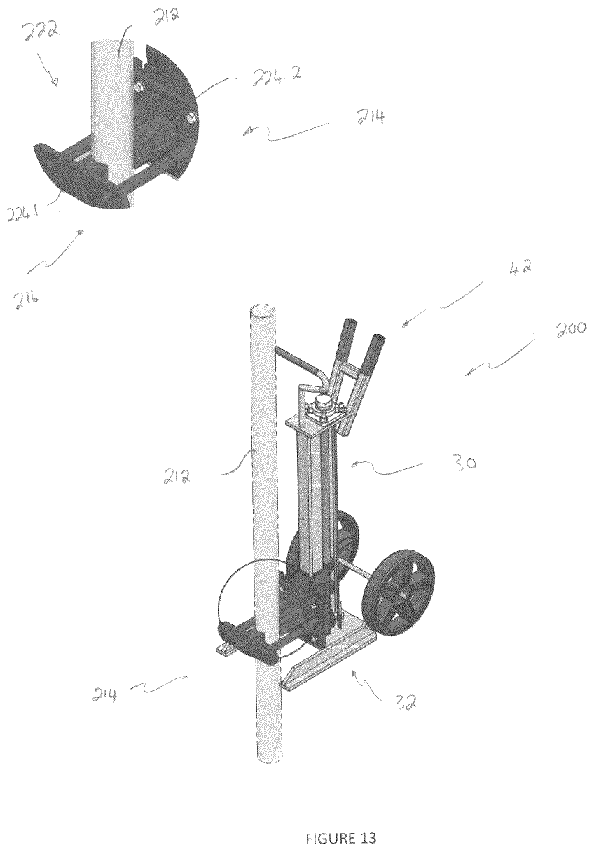

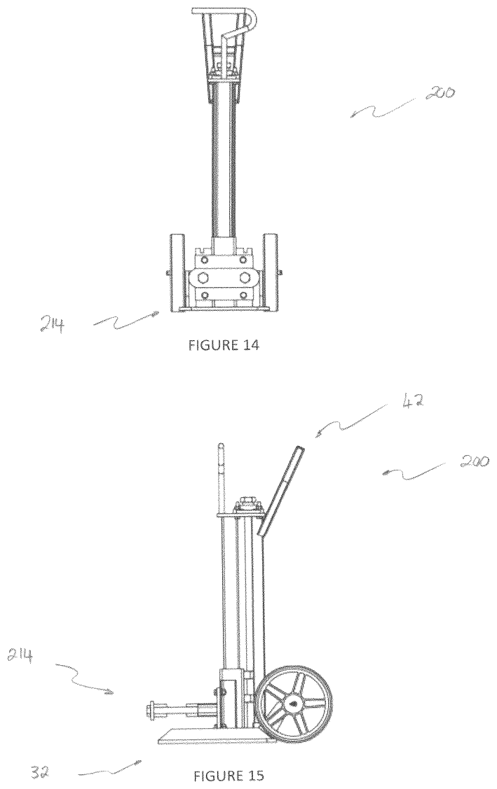

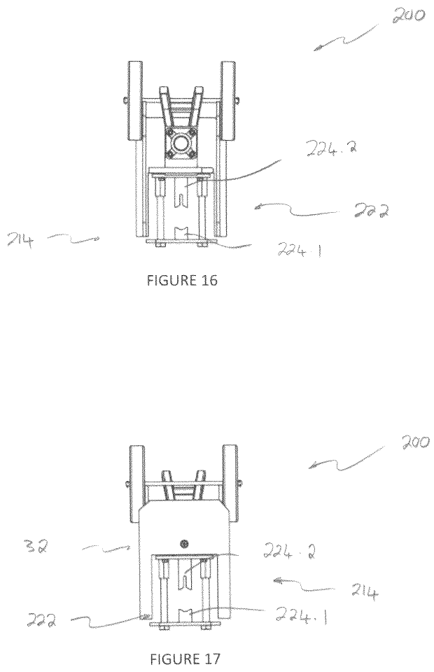

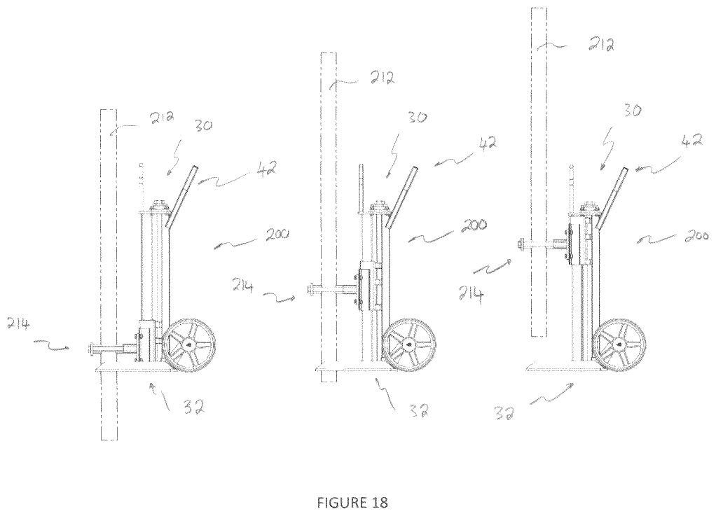

FIGS. 13 to 18 show a third embodiment extractor 200 which includes a guide assembly 24, drive assembly 30, base 32 and hand tool holder 42 similar to the second embodiment extractor 100. The extractor 200, however, differs from the extractor 100 in having a holding assembly 214 which defines a clamp 216 operatively adapted to clamp onto an elongate body 212. The clamp 216 includes a gripping formation 222 complementally shaped to the outer surface of the elongate body 212 to be extracted. In this embodiment the gripping formation 222 is shaped to accommodate the outer shape of the elongate body 212 provided in the form of a pipe post. The gripping formation 222 includes two opposing gripping members 224.1, 224.2 which co-operate to grip the outer surface of the pipe post 212 when it is to be extracted from the ground.

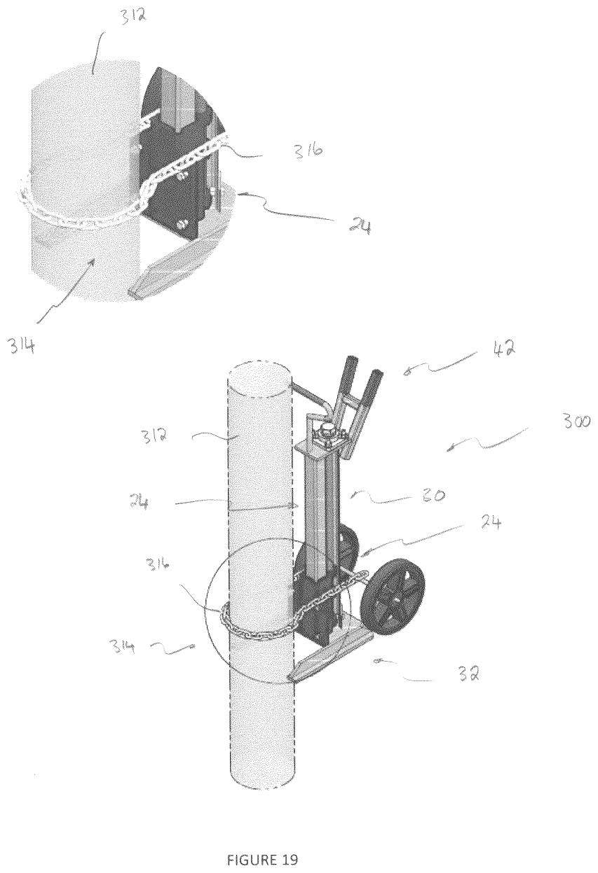

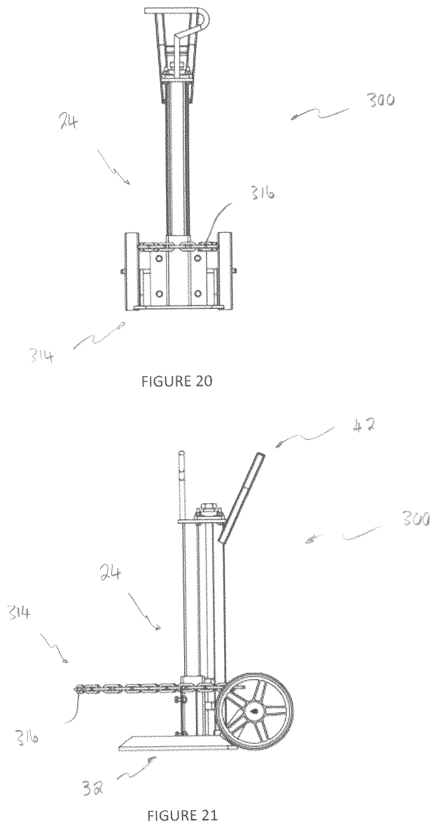

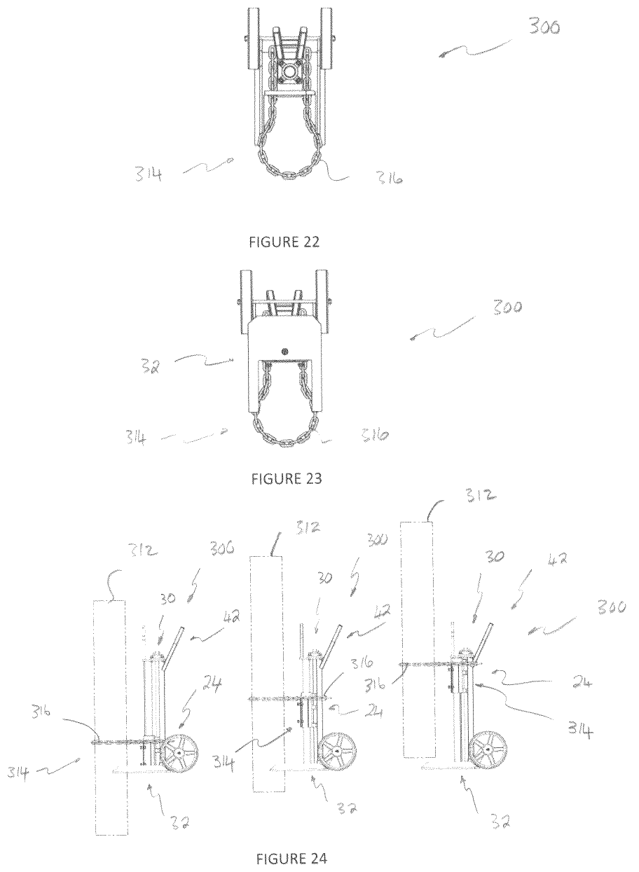

FIGS. 19 to 24 show a fourth embodiment extractor 300 which includes a guide assembly 24, drive assembly 30, base 32 and hand tool holder 42, similar to the first embodiment extractor 10. The extractor 300, however, differs from the extractor 10 in having a holding assembly 314 which includes a chain 316 operatively adapted to grip a timber strainer post 312.

In a non-illustrated embodiment, the gripping formation is shaped to accommodate the outer shape of a T-picket.

Although the invention has been described with reference to a specific example, it will be appreciated by those skilled in the art that the invention may be embodied in many other forms.

### KEY TO REFERENCE NUMERALS IN DRAWINGS

10 Extractor (first embodiment)
12 Elongate body (bulkhead pin)
14 Holding assembly
16 Upper end
18.1 Upper flange
18.2 Lower flange
20 Holding member
22 Slot
24 Guide assembly
26 Guide follower
28 Guide
30 Drive assembly
32 Base
34 Base member
36.1 Base arm
36.2 Base arm
38 Coupling
40 Hexagonal coupling head
42 Hand tool holder
44 Upright support
46.1 Holder arm
46.2 Holder arm
48 Rest
50.1 Wheel
50.2 Wheel
52 Axle
54 Handle
56 Drive rod
58 Coupling end
60 Base end
62 Drive rod engaging formation
64.1 Internally threaded ear
64.2 Internally threaded ear
64.3 Internally threaded ear
66 Bore
100 Extractor (second embodiment)
112 Elongate body (star picket)
114 Holding assembly
116 Clamp
118 Clamp element
120 Fasteners
122 Gripping formation
124.1 Gripping member
124.2 Gripping member
200 Extractor (third embodiment)
212 Elongate body (pipe post)
214 Holding assembly
216 Clamp
222 Gripping formation
224.1 Gripping member
224.2 Gripping member
300 Extractor (fourth embodiment)
312 Elongate body (timber strainer post)
314 Holding assembly
316 Chain

1. An extractor for extracting an elongate body from the ground, the extractor including:
a holding assembly operatively adapted to hold the elongate body to be extracted from the ground;
a guide assembly operatively associated with the holding assembly, the guide assembly including (i) a guide follower for operative attachment to the holding assembly, and (ii) a guide along which the guide follower is caused to move when the elongate body is extracted from the ground; and
a drive assembly operatively associated with the guide follower, the drive assembly adapted to be coupled with a hand tool for applying torque to the drive assembly, applying torque to the drive assembly causing the guide follower to move along the guide, thereby to extract the elongate body from the ground.

2. An extractor according to claim 1, including a base adapted to support the guide assembly in an upright orientation when the elongate body is extracted from the ground.

3. An extractor according to claim 2, including a base member and two co-extensive, laterally spaced apart base arms outwardly extending from the base member.

4. An extractor according to claim 1, wherein the drive assembly includes a coupling adapted to couple with the hand tool, the coupling in use transferring torque from the hand tool to the drive assembly.

5. An extractor according to claim 4, wherein the hand tool is cordless drill or a powered cordless impact wrench.

6. An extractor according to claim 4, wherein the coupling includes a hexagonal coupling head.

7. An extractor according to claim 1, including a hand tool holder operatively adapted to support the hand tool.

8. An extractor according to claim 7, wherein the hand tool holder is secured to an upright support mounted to the base member.

9. An extractor according to claim 8, wherein the hand tool holder includes two spaced apart holder arms which are connected by a transverse rest.

10. An extractor according to claim 1, including at least one wheel for transporting the extractor to a desired location.

11. An extractor according to claim 10, including a handle whereby a user steers the extractor to a desired location.

12. An extractor according to claim 1, wherein the drive assembly includes an elongate, longitudinally extending threaded drive rod.

13. An extractor according to claim 12, wherein the guide follower includes a threaded drive rod engaging formation, the drive rod engaging formation adapted to engage the drive rod such that pivotal movement of the drive rod imparts relative movement to the rod engaging formation, thereby causing the guide follower to move longitudinally along the guide.

14. An extractor according to claim 13, wherein the guide is an elongate upright.

15. An extractor according to claim 1, wherein the holding assembly includes a holding member having a slot adapted to slidably receive a portion of the elongate body.

16. An extractor according to claim 1, wherein the holding assembly includes a clamp operatively adapted to clamp onto the elongate body.

17. An extractor according to claim 16, wherein the clamp includes a gripping formation complementally shaped to the outer surface of the elongate body to be extracted.

18. An extractor according to claim 17, wherein the gripping formation is shaped to accommodate the outer surface of an elongate post body selected from the group consisting of a star picket, a T-picket, and a pipe post.

19. An extractor according to claim 1, wherein the holding assembly includes a chain.
